(19) United States
(12) Patent Application Publication
(10) Pub. No.: US 2010/0006026 A1
(43) Pub. Date: Jan. 14, 2010

(54) DEVICE FOR APPLYING LIQUID COATING MATERIALS

(76) Inventors: Juergen Goetz, Oberriexingen (DE); Thilo Koeder, Gerlingen (DE)

Correspondence Address: MICHAEL J. STRIKER, 103 EAST NECK ROAD, HUNTINGTON, NY, 11743, US

(21) Appl. No.: 12/444,949

(22) PCT Filed: Jun. 6, 2008
(86) PCT No.: PCT/EP2008/057107

§ 371 Date: Apr. 9, 2009

(30) Foreign Application Priority Data
Jul. 30, 2007 (DE) 10 2007 035 703.

(51) Int. Cl. B05B 9/03

(52) U.S. Cl. 118/300

(57) ABSTRACT

The invention relates to a device (1) for applying liquid coating materials, particularly paints, onto an application surface (8), comprising an ejection system (11) for the coating material, wherein the coating material is fed to a displacement chamber (12), is applied in the displacement chamber (12) by means of a displacement element (13), is fed from the displacement chamber (12) to a throttle (26) in metered doses and is then forcefully ejected via the throttle opening (5) thereof against the application surface (8) in the form of droplets.

The invention relates to a device for applying liquid coating materials to an application surface, in particular for applying paint to a wall surface, as generically defined by the preamble to claim 1.

### PRIOR ART

Applying coating material in the form of paint, in particular viscous dispersion paint, to walls is done both by professionals and in the do-it-yourself field using paint rollers, spray systems, brushes, or sponge systems. Each of these systems requires complex work preparation, to avoid soiling the surrounding area with paint spatters or paint spray and/or to limit the application of the paint layer to a defined work area, for instance at the transition to baseboards, built-in furniture, door frames, or the like. It is especially difficult to stay within paint application boundaries whenever different colors of paint in special forms are to be applied to regions of the surface to which paint is to be applied that are demarcated from one another.

### DISCLOSURE OF THE INVENTION

It is the object of the invention to embody a device of the type defined at the outset, with a robust, simple, and easily manipulated makeup, in such a way that uniform emission of the coating material, especially dispersion paint to be applied to wall surfaces, is reliably assured.

According to the invention, this is attained with the characteristics of claim 1. The dependent claims recite expedient refinements.

The device functions for this purpose with an expulsion system for the coating material, in which the coating material is delivered to a positive-displacement chamber, acted upon in the positive-displacement chamber by a positive-displacement element, delivered in apportioned form from the positive-displacement chamber to a nozzle, and expelled via its nozzle opening in droplet form in shotlike fashion against the application surface.

Via a positive-displacement element, in particular in its embodiment as a pump plunger, the inflow of coating material to the positive-displacement chamber and/or the cyclical apportioning of the coating material to be delivered from the positive-displacement chamber to the nozzle opening can be attained in a simple way, and the connection between the positive-displacement chamber and the nozzle opening can be easily controlled in its cross section. Furthermore, particularly as a function of the reciprocation speed of the pump plunger, the pressure at which the nozzle material is expelled via the nozzle opening can also be determined, so that the positive-displacement system according to the invention opens up manifold possibilities in terms of design and/or adaptation to various coating materials and/or the viscosity of the particular coating material, such as the particular dispersion paint.

Moreover, by way of the design of the nozzle opening as well as the definition of the cross section between the positive-displacement chamber and the nozzle opening, the particular droplet size and/or droplet shape of the expelled coating material can be varied.

In addition, by the embodiment of the transition between the nozzle opening and the positive-displacement chamber, the sharpness of the separation between successive droplet formations can also be varied, and a capillary embodiment, for instance in the form of a capillary channel, proves expedient.

In terms of the embodiment of the droplet and the detachment of the droplet from the nozzle, it is advantageous if the nozzle opening is surrounded by a nozzle collar which, particularly on the outlet side, is slender in its wall thickness.

In particular, the nozzle collar can be designed in bladelike fashion on the outlet side.

Since the particular droplet to be formed is determined in size and shape jointly via the nozzle opening and the connection between the nozzle opening and the positive-displacement chamber, and above all is also determined as a function of the consistency of the particular coating material or in other words especially the particular paint, it proves expedient for at least these parts to be provided in a nozzle plate, which is preferably joined to the device housing replaceably relative to the device housing, in particular via a fast-action closure system. The device housing in turn expediently receives the positive-displacement element and the actuator associated with it.

The positive-displacement chamber is preferably also associated with the nozzle plate. Within the scope of the invention, the nozzle, the positive-displacement chamber, and the nozzle and positive-displacement chamber can optionally be embodied as an insert to the nozzle plate, and the nozzle plate can in turn be embodied in one or more parts.

With a view to the embodiment of the device with a plurality of expulsion systems, each having one nozzle, it proves to be expedient to accommodate the nozzles together in a nozzle plate, so that by replacing the particular nozzle plate, it is possible to make an adaptation to given work requirements. The various nozzle plates may differ both in terms of the number of nozzles provided for each and in terms of their arrangement; arrangements in which the nozzles are in rows relative to one another, optionally in groups, are expedient, so that on a case by case basis a joint action on the various positive-displacement elements, in particular the pump plungers, will be easily possible.

This kind of arrangement in rows also proves expedient for bundling the supply lines required for supplying the various positive-displacement chambers, such as the positive-displacement chambers belonging to one row of nozzles, jointly. This is made easier if the nozzles, which is preferred within the scope of the invention, are located with the associated positive-displacement chambers and the supply lines for them in the respective nozzle plate.

By comparison, accommodating the actuator or actuators for the positive-displacement elements, in particular pump plungers, in the housing part of the device proves expedient, so that replacing nozzle plates with the same arrangement of nozzles provided in them but with a different embodiment of the nozzles has no influence on the remaining makeup of the device.

A mechanical eccentric or crank drive proves expedient as an actuator for the device by way of which positive-displacement elements can be acted upon individually or in groups and optionally also shut off individually or in groups, and this is specifically true in combination with a respective linear guide for the positive-displacement element, preferably embodied as a pump plunger; in an especially simple embodiment, a plurality of pump plungers are acted upon via a common supporting beam and/or are associated with the common supporting beam, which is adjustable in terms of stroke via a common eccentric or crank drive.

Further advantages and expedient embodiments can be learned from the further claims, the description of the drawings, and the drawings. Shown are:

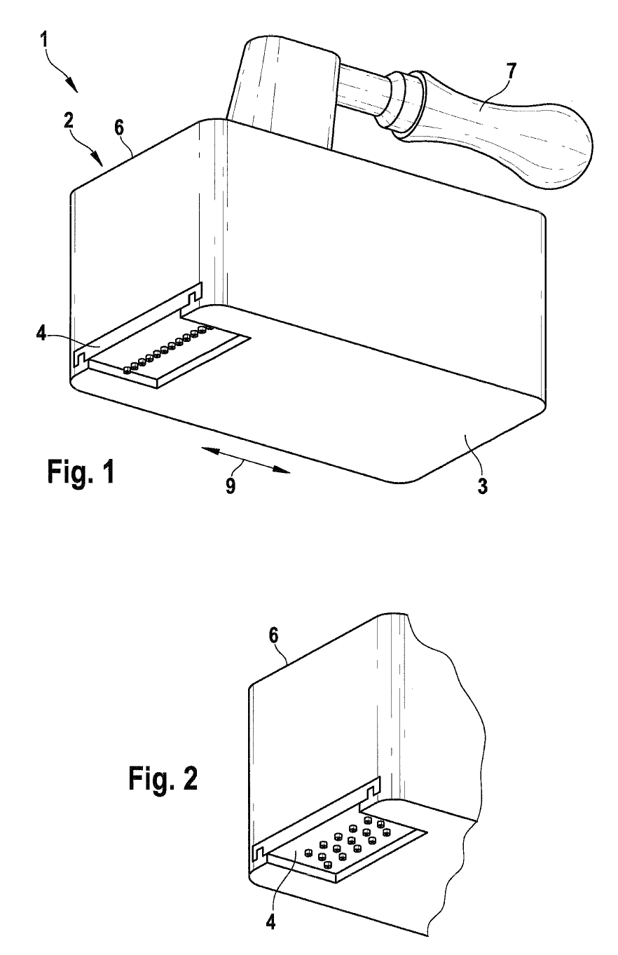

FIG. 1, a perspective view of a basic illustration of a device for applying liquid coating materials, in particular paints, to an application surface, in which a nozzle plate with nozzle openings as outlet openings for the coating material is provided in the underside of the device, the underside being oriented toward the application surface in the working position of the device;

FIG. 2, in a view corresponding to FIG. 1, a detail of the device having a nozzle plate that includes a plurality of rows of nozzle openings;

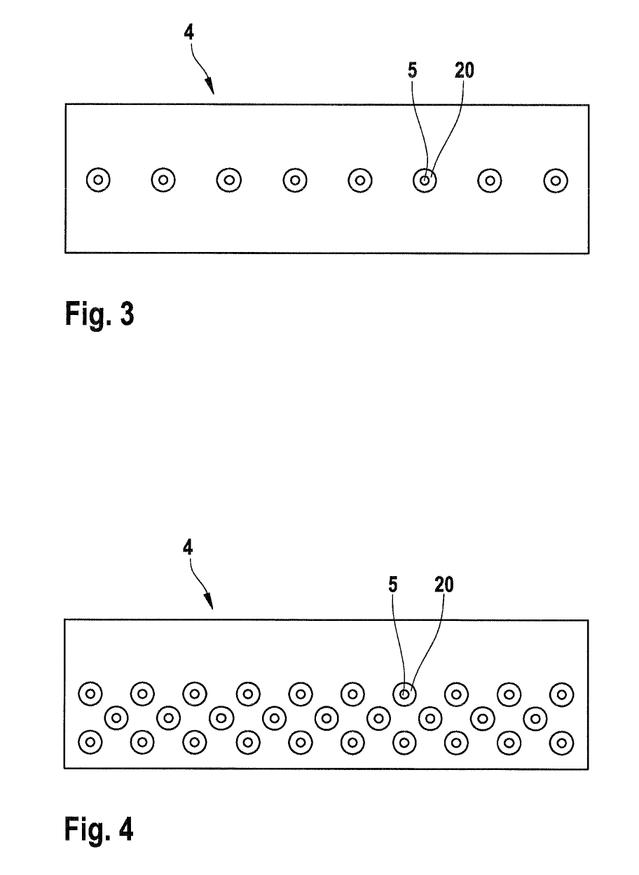

FIGS. 3 and 4, plan views on the underside of the device of FIG. 1 or FIG. 2, in which the various nozzle plates are shown in isolation;

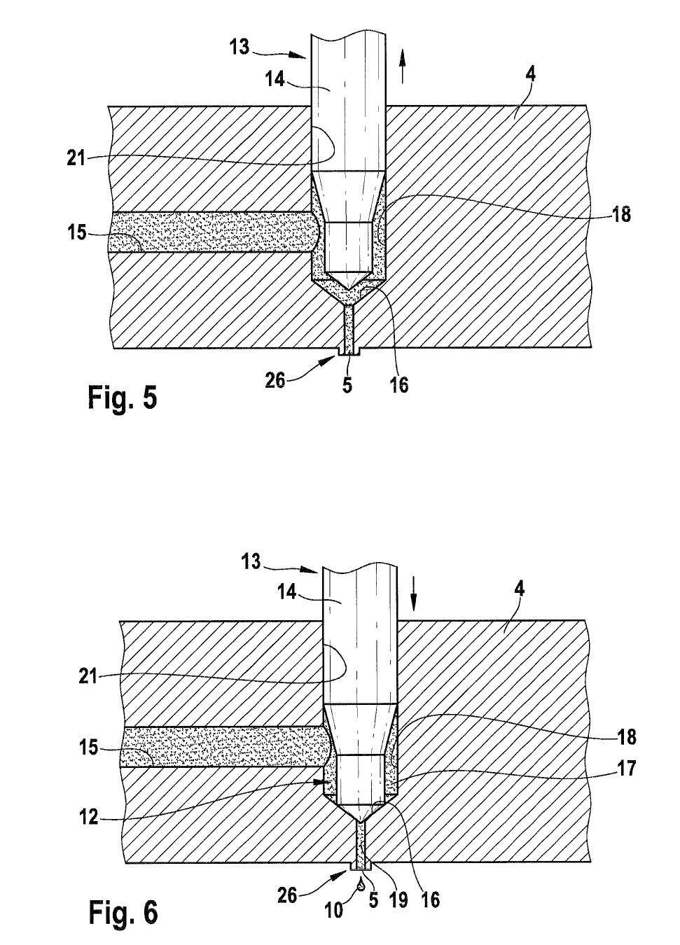

FIGS. 5 and 6, each schematically, a nozzle part of an expulsion system that is used in devices according to FIG. 1 or FIG. 2, in which what is shown of the respective expulsion system is a pump plunger forming a positive-displacement element, in engagement with a positive-displacement chamber where the nozzle originates; FIG. 5 shows the pump plunger in its upward motion as the positive-displacement chamber is being filled, and FIG. 6 shows the pump plunger in its downward motion toward the filling chamber;

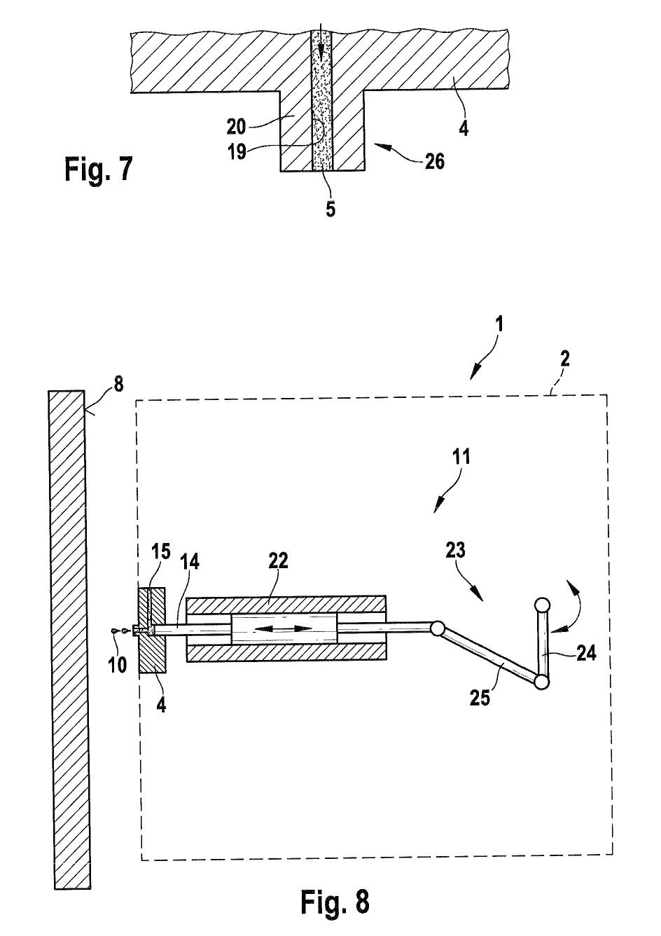

FIG. 7, a highly schematic and enlarged view of the part of the nozzle containing the nozzle opening, in section; and

FIG. 8, a schematic illustration, explaining the makeup and function of the device, in which the housing of the device is shown in dashed lines as a surrounding frame, specifically in association with an application surface onto which the coating material is to be applied by means of the device.

The housing 2 of the device 1, in its bottom 3, has an inserted nozzle plate 4 with nozzle openings 5. On the top side 6, diametrically opposite the bottom 3, the device 1 is provided with a handle 7.

In principle, the handle 7 may also be provided laterally of the device 1. Although this is not shown, the device 1 is expediently provided in the region of the bottom 3, and optionally also laterally cantilevered relative to the bottom 3, with supporting elements, such as rollers, wheels, or the like, by way of which a preferred working spacing from the application surface 8, indicated in FIG. 8, can be set and adhered to as a minimum spacing.

FIGS. 1 through 4 show that the device 1 can be operated in conjunction with various arrangements of nozzle openings 5; FIG. 3, corresponding to FIG. 1, shows an arrangement of the nozzle openings 5 in one row, while FIG. 4 in conjunction with FIG. 2 shows an arrangement of nozzle openings 5 in a plurality of rows. The rows of nozzle openings 5 each extend transversely to a working direction symbolized by the arrow 9.

The nozzle plates 4, although this cannot be seen from the views in FIGS. 1 and 2, are preferably fixed replaceably to the housing 2 and in particular are braced, for instance in sliding guides of the side walls of the housing 2; the particular working position of the nozzle plate 4 can be secured by a lock, in particular a snap closure. Disposing the nozzle plate 4 that contains the nozzle openings 5 detachably relative to the housing 2 also makes it possible in particular to detach the nozzle plate 4 from the housing 2 for cleaning purposes, so that not only the replacement of nozzle plates 4 variously equipped with nozzle openings 5, but also simple and fast maintenance of the device 1 are assured, which is of major practical importance for working with coating materials, such as paints in particular, like dispersion paints.

Via the nozzle openings 5, the particular liquid coating material, thus in particular a given paint, is applied to the application surface 8; the coating material is expelled in the form of droplets—droplets 10 are indicated in FIG. 8—in the direction of the application surface 8 and also in droplet form strike the application surface 8, where the droplets 10 join to form a covering, in particular a closed, filmlike layer of paint, that covers the application surface 8. The paint layer thus achieved is equivalent in the end and in quality to at least that when paint is applied with brushes, rollers or the like, but also makes continuous work possible without soiling the surroundings, either from paint spatters or paint spray, since the droplet structure of closed circumference, defined upon expulsion via the nozzles 26, of the coating material is maintained until it strikes the application surface 8, and on the application surface 8, the droplets 26 merely flatten, in accordance with the layer thickness sought, and with the droplets adjoining them form a closed covering layer.

This is achieved with an expulsion system 11 as shown in diagram form in FIG. 8 and schematically with associated details, including the associated drive mechanism, in FIGS. 5 through 7. The expulsion system 11 provided in the housing 2, beginning at the applicable nozzle opening 5, includes a positive-displacement chamber 12 communicating with the nozzle opening, into which chamber a positive-displacement element 13 plunges that in the exemplary embodiment is designed as a pump plunger 14; on its face end, the pump plunger 14 is adapted in its contour to the domelike contour of the positive-displacement chamber 12 at the transition to the nozzle 26 and its nozzle opening 5. As the inlet for the coating material, an inlet conduit 15 discharges toward the positive-displacement chamber 12; in the exemplary embodiment, this conduit laterally adjoins the positive-displacement chamber 12, and discharges, when the pump plunger 14 plunges into the dome 16 of the positive-displacement chamber 12, at an rr 17, which is defined radially inward in this region by means of a reduction of the circumference of the positive-displacement element 13. In the guide region for the pump plunger 14, which region tapers toward the dome 16, the pump plunger is guided in the bore 18 receiving it, so that the positive-displacement chamber 12 is axially sealed off by way of the part of the pump plunger 14 that extends within the guide bore 18.

At the apex, the dome 16 is in communication with the nozzle opening 5; in the exemplary embodiment, this communication is formed by a capillary that continues on into the nozzle opening 5, and the nozzle opening 5 is surrounded by a nozzle collar 20 that projects past the bottom of the nozzle plate 4 and comes to an end as a thin-walled, tubular projection, preferably in bladelike fashion, optionally widening in the direction of the blade, so that the droplet 10 detaches without residue from the guide formed by the capillary. if the spacing between the nozzle opening 5 and the positive-displacement chamber 12 is reduced to the minimum necessary for reasons of strength, the result for the capillary 19 is a very short length, but depending on the type of coating material to be handled, especially its viscosity, greater lengths may optionally be specified for the capillary 19 instead, depending on its diameter.

Via the pump plunger 14, in its working stroke, the coating material is expelled from the positive-displacement chamber 12 in the direction of the nozzle opening 5, as is shown in FIG. 6. If the pump plunger 14 is retracted, then the positive-displacement chamber 12 becomes larger and is filled via the inflow conduit 15; the inflow of coating material via the inflow conduit 15 to the positive-displacement chamber 12 preferably takes place at pilot pressure, in particular a slight pilot pressure of a few bar, so that depending on the operating frequency of the pump plunger 14, and given free communication between the inflow conduit 15 and the positive-displacement chamber 12, a medium pressure is established, at which the coating material is positively displaced in the direction of the nozzle opening 5 and expelled via the nozzle opening 5. The nozzle opening 5 and the positive-displacement chamber 12, with an adjoining guide part 21 for the pump plunger 14 that is sealed off via the pump plunger 14, are located inside the nozzle plate 4, as shown in FIGS. 5 and 6. The drive for the pump plunger 14, including a linear guide for the pump plunger 14, is braced inside the housing 2 independently of the nozzle plate 4, given a corresponding alternating orientation. The linear guide for the pump plunger 14 is indicated at 22 in FIG. 8, and as the drive for the pump plunger 14, an eccentric or crank drive 23 is provided, whose eccentric or crank arm 24 is connected via a connecting rod 25 to the pump plunger 14 extending in the linear guide 22, so that the drive originating at the motor, not shown, takes the overall form of a thrust crank drive acting on the pump plunger 14.

This kind of mechanical drive proves expedient for the pump plunger in view of the operating frequencies on the order of magnitude of approximately 100 Hz that are sought, in order to make do with as small as possible a drive unit; in principle, one such drive unit may be associated with each pump plunger 14.

However, as a common drive for a plurality of pump plungers 14, a drive source may be provided that drives an eccentric or crank shaft, whose eccentric elements or cranks are each connected to one pump plunger 14. Moreover, a common drive for a plurality of pump plungers 14 may include a supporting beam connected to the pump plungers 14, which is acted upon via an eccentric or crank drive. In particular, the pump plungers 14 associated with the nozzles 26 of a row of nozzle openings 5 can thus also be driven in common.

A common supply is expediently provided for the positive-displacement chambers 12, which communicate with one another via corresponding inflow conduits 15 that in turn are connected to a supply reservoir for the coating material, which may be located inside the housing 2, so that the device is an independent handheld work device. Optionally, the device 1 may also be in communication with an external supply container, and it proves expedient to associate at least one temporary storage means with the device 1 in encapsulated fashion in the housing 2, so that as needed, for instance depending on position, work is still possible even independently of the external supply container. For the eccentric or crank drive, an electric motor, which is not shown, is preferably provided, integrated with the device 1 and in particular located in the housing 2.

Overall, the device 1 thus proves to be a lightweight handheld power tool that in particular can be operated with good results even by relatively inexperienced users, and for driving it, hydraulic or pneumatic drives, among others, may also be considered.

For the embodiment of the device, particularly with regard to the diameter of the pump plunger 14, dimensions of 1 to 3 mm, preferably approximately 2.5 mm, prove expedient; also, the stroke of the pump plunger 14 is preferably approximately 1 to 10 mm, in particular 7 mm, and the frequency of the pump plunger 14 is approximately 50 to 120 Hz, in particular 100 Hz. The inflow pressure is preferably approximately 0.5 to 1.5 bar, and particularly in the range around 1 bar. For the capillaries, diameters of approximately 0.3 to 0.6 mm, and preferably approximately 0.4 mm, prove expedient; the length of the capillary is in particular in the range of 0.5 to 6 mm. For the droplets, droplet diameters of approximately 1.5 to 3 mm, and in particular approximately 2.2 mm, prove expedient in order to achieve a uniform coating, and in particular a uniformly covering application of paint.

1. A device (1) for applying liquid coating materials to an application surface (8), in particular for applying paint to a wall surface, characterized in that the device (1) has an expulsion system (11) for the coating material, in which the coating material is delivered to a positive-displacement chamber (12), acted upon in the positive-displacement chamber (12) by a positive-displacement element (13), delivered in apportioned fashion from the positive-displacement chamber (12) to a nozzle (26), and via its nozzle opening (5) is expelled in droplet form in shotlike fashion against the application surface (8).

2. The device as defined by claim 1,
characterized in that the positive-displacement element (13) is embodied as the inlet to pump plungers (14) that control the nozzle opening (5).

3. The device as defined by claim 1,
characterized in that the positive-displacement element (13) is embodied as the inlet to pump plungers (14) controlling the positive-displacement chamber (12).

4. The device as defined by claim 1,
characterized in that the positive-displacement chamber (12) is embodied as coming to an end in domelike fashion in the direction toward the nozzle opening (5).

5. The device as defined by claim 1,
characterized in that the positive-displacement chamber (12) communicates with the nozzle opening (5) via a capillary channel.

6. The device as defined by claim 1,
characterized in that the nozzle opening (5) is surrounded by a nozzle collar (20).

7. The device as defined by claim 1,
characterized in that the nozzle (26), at least coming to an end toward the nozzle opening (5), is a component of a nozzle plate (4) that belongs to the housing (2) of the device (1).

8. The device as defined by claim 7,
characterized in that the nozzle plate (4) of the device housing (2) is replaceable.

9. The device as defined by claim 7,
characterized in that the nozzle plate (4) is fixable on the device housing (2) by means of a fast-action closure.

10. The device as defined by claim 1,
characterized in that a crank or eccentric drive (23) is provided as the actuator for a pump plunger (14).

11. The device as defined by claim 1,
characterized in that one common actuator is provided for a plurality of pump plungers (14).

12. The device as defined by claim 1,
characterized in that the device (1) is embodied as an electrically operated, in particular noncordless handheld power tool.

13. The device as defined by claim 1,
characterized in that the device (1) includes an integrated storage chamber, embodied in particular as a temporary storage means, for coating material.

14. The device as defined by claim 1,
characterized in that the device (1) is connected to an external supply for coating material.
